(19) United States
(12) Patent Application Publication
(10) Pub. No.: US 2025/0018879 A1
(43) Pub. Date: Jan. 16, 2025

(54) VEHICLE EXTERIOR COMPONENT

(71) Applicant: TOYODA GOSEI CO., LTD., Kiyosu-shi (JP)

(72) Inventors: Yuhki KURAMITSU, Kiyosu-shi (JP); Yoshiharu TANAKA, Kiyosu-shi (JP); Tsuyoshi SUZUKI, Kiyosu-shi (JP)

(21) Appl. No.: 18/762,265

(22) Filed: Jul. 2, 2024

(30) Foreign Application Priority Data
Jul. 11, 2023 (JP) 2023-113741

(51) Int. Cl. B60R 13/00; B60Q 1/50; B60R 13/04; F21S 43/50; F21V 3/04; G01S 7/02; G01S 13/931

(52) U.S. Cl. CPC B60R 13/005; B60R 13/04; F21S 43/50; G01S 7/028; G01S 13/931; B60Q 1/50; F21V 3/04; G01S 2013/93271

(57) ABSTRACT

A vehicle exterior component includes a housing arranged in a vehicle, an ornamental body located outward from the housing with respect to the vehicle, and a light source arranged in the housing. The ornamental body includes a base formed from a transparent or translucent material, and a decorative layer laminated to an outer surface or an inner surface of the base. The decorative layer includes a first colored layer, which is light-transmissive and formed from a pigmented coat, and a second colored layer, which is light-transmissive, laminated to an inner side of the first colored layer, and includes fillers dispersed in coat. The fillers each include a filler body and a coating that coats the filler body. The coating is formed by a pigmented coat of which a color difference ΔE from the pigmented coat of the first colored layer is 30 or less.

### CROSS-REFERENCE TO RELATED APPLICATIONS

This application is based upon and claims the benefit of priority from prior Japanese Patent Application No. 2023-113741, filed on Jul. 11, 2023, the entire contents of which are incorporated herein by reference.

### BACKGROUND

### 1. Field

The present disclosure relates to a vehicle exterior component.

### 2. Description of Related Art

Japanese Laid-Open Patent Publication No. 2005-88652 discloses a vehicle exterior component that includes a base and a colored layer, such as a blue layer. The base is formed from a transparent or translucent material. The colored layer is laminated to the outer surface or the inner surface of the base. Many fine holes, having a diameter of about several tens to several hundreds of micrometers, extend through the colored layer.

When the vehicle is in a bright environment and a light source of the vehicle exterior component is off, the blue color of the colored layer can be seen from outside the vehicle. When the vehicle is in a dark environment and the light source of the vehicle exterior component is on, the light emitted from the light source passes through the holes. Thus, the light passing through the holes can be seen from the outside the vehicle. This allows for the vehicle exterior component to be expressed in colors that differ between when the light source is off, such as during daytime, and when the light source is on, such as during nighttime.

In the above-described vehicle exterior component, although the holes have small diameters, the holes are still visible from outside the vehicle when the light source is off. The holes may be decreased in diameter so that they would not be visible. This would, however, hinder the passage of light. Since less light would be passing through the vehicle exterior component, this would darken the pattern or the like that is expressed with light.

Thus, there is still room for improvement to the aesthetic appeal of the vehicle exterior component when the light source is on and when the light source is off.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a vehicle exterior component includes a housing arranged in a vehicle, an ornamental body located outward from the housing with respect to the vehicle, and a light source arranged in the housing to emit light that strikes an inner surface of the ornamental body. The inner surface of the ornamental body faces inward with respect to the vehicle. The ornamental body includes a base formed from a transparent or translucent material, and a decorative layer laminated to an outer surface or an inner surface of the base. The outer surface of the base is located outward from the inner surface of the base with respect to the vehicle. The decorative layer includes a first colored layer and a second colored layer. The first colored layer is light-transmissive and formed from a pigmented coat. The second colored layer is light-transmissive, laminated to an inner side of the first colored layer, and includes fillers dispersed in a coat. The inner side of the first colored layer faces inward with respect to the vehicle. The fillers each include a filler body and a coating that coats the filler body. The coating is formed by a pigmented coat of which a color difference ΔE from the pigmented coat of the first colored layer is 30 or less.

Other features and aspects will be apparent from the following detailed description, the drawings, and the claims.

### BRIEF DESCRIPTION OF THE DRAWINGS

FIG. 1 is a plan view showing one embodiment of a vehicle exterior component.

FIG. 2 is a cross-sectional view taken along line 2-2 in FIG. 1.

FIG. 3 is an enlarged cross-sectional view of an ornamental body shown in FIG. 2.

FIG. 4 is a schematic diagram illustrating a first light component, reflected by a filler coating surface, superimposed with a second light component, reflected by a filler body surface, to intensify the combined light.

FIG. 5 is a schematic diagram showing the structure of a decorative layer and a light source.

FIG. 6 is a schematic diagram illustrating the light emitted from the light source that changes in color when passing through different colored layers, which are shown in FIG. 5.

FIG. 7 is a graph showing the reflectance of the decorative layer illuminated with light from outside the vehicle, measured for different wavelengths.

FIG. 8 is a graph showing the transmittance of the decorative layer illuminated with light from outside the vehicle, measured for different wavelengths.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Embodiments of a vehicle exterior component will now be described with reference to the drawings.

In the description hereafter, the front direction corresponds to the forward direction of a vehicle 10, and the rear direction corresponds to the rearward direction of the vehicle 10. Further, the upper and lower directions of the vehicle 10 will be referred to as the vertical direction. The left and right directions, or transverse direction, correspond to the left and right directions when the vehicle 10 moves forward.

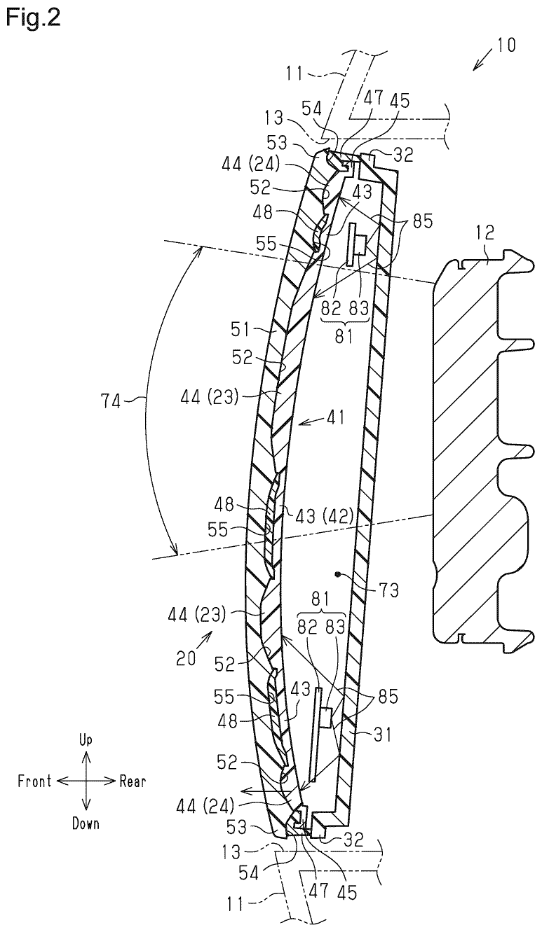

As shown in FIG. 2, the vehicle 10 includes a front grille 11. A millimeter wave radar device 12, which serves as a sensor that detects on object outside the vehicle 10, is arranged in the front middle part of the vehicle rearward from the front grille 11. The millimeter wave radar device 12 transmits millimeter waves, which are electromagnetic waves, toward the front of the vehicle 10 within a predetermined angular range. The millimeter wave radar device 12 receives the millimeter waves reflected by an object outside the vehicle 10 such as another vehicle (front vehicle) or a pedestrian.

The front grille 11 includes a window 13 located in front of the millimeter wave radar device 12 to allow for passage of the millimeter waves transmitted from the millimeter wave radar device 12. A vehicle exterior component 20 is arranged in the window 13 held upright facing the front direction.

The terms inward, inner side, outward, and outer side with respect to the vehicle 10 will be used to described the positional relationship of the various parts of the vehicle exterior component 20 and the positional relationship of the vehicle exterior component 20 and the millimeter wave radar device 12. For example, in the front-rear direction, the inner direction is the direction extending toward the central part of the vehicle 10, and the outer direction is the direction extending away from the central part of the vehicle 10. The inner and outer directions with respect to the vertical direction and the transverse direction are defined in the same manner as the front-rear direction.

The vehicle exterior component 20 is arranged facing forward, and the vehicle exterior component 20 is arranged in front of the millimeter wave radar device 12. Thus, in the present embodiment, the outer and inner directions will be used with respect to the front-rear direction. The vehicle exterior component 20 and the millimeter wave radar device 12 are located in the front part of the vehicle 10, and the vehicle exterior component 20 is located in front of the millimeter wave radar device 12. Thus, the outer side corresponds to the front side in the present embodiment. The inner side corresponds to the rear side with respect to the front-rear direction.

The vehicle exterior component 20 increases the aesthetic appeal of the exterior of the vehicle 10. The vehicle exterior component 20 of the present embodiment is generally referred to as an emblem. The vehicle exterior component 20 includes a housing 31, an ornamental body 41, and light sources 81. The various parts of the vehicle exterior component 20 will now be described.

### Housing 31

The housing 31 is located outward from the millimeter wave radar device 12 in the vehicle 10. The housing 31 is transmissive to the millimeter waves transmitted from the millimeter wave radar device 12.

The housing 31 is entirely formed from a plastic material in which a white light diffuser is dispersed. The plastic material is acrylonitrile ethylene styrene (ABS). Instead, the plastic material may be, for example, a polymer alloy of polycarbonate (PC) and ABC. The light diffuser is, for example, a metal oxide such as titanium oxide or zinc oxide. When illuminated with light, the housing 31 diffusively reflects white light.

### Ornamental Body 41

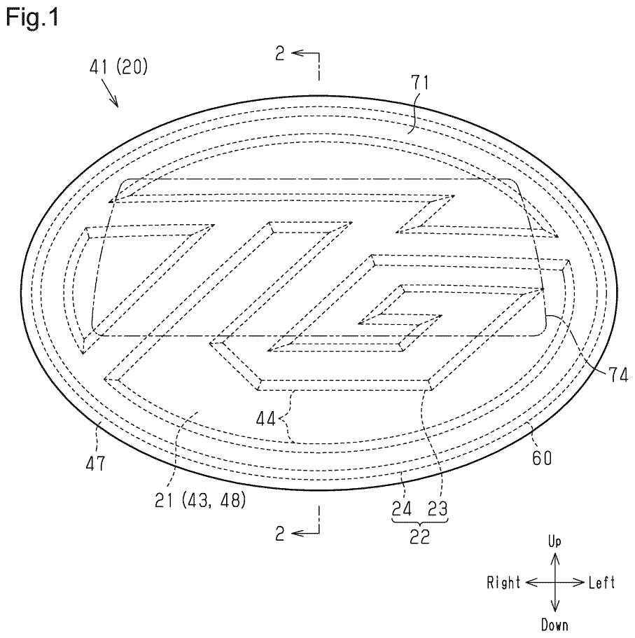

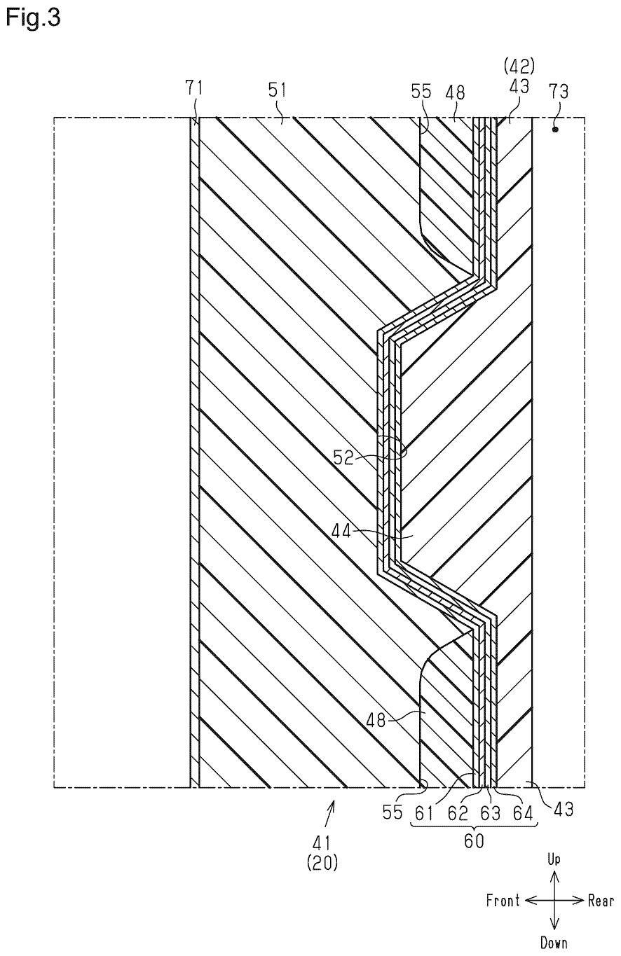

As shown in FIGS. 1 and 2, the ornamental body 41 is located outward from the housing 31. The ornamental body 41 has the form of a plate with an overall elliptical shape elongated in the transverse direction. As shown in FIGS. 2 and 3, the ornamental body 41 includes a base, which is formed from a transparent or translucent material, a light shield, a decorative layer 60, and a hard coat layer 71. The base is formed by an inner base 42 and an outer base 51, which is located outward from the inner base 42. FIG. 2 does not show the decorative layer 60 and the hard coat layer 71.

### Inner Base 42

The inner base 42 is transmissive to millimeter waves. The inner base 42 is formed from a transparent plastic material, which serves as the transparent material, such as acrylonitrile styrene (AS), PC, or poly(methyl methacrylate) (PMMA). The inner base 42 may be formed from a translucent plastic material, which serves as the translucent material.

The inner base 42 includes a general portion 43 and a projection 44, which projects outward from the general portion 43. The general portion 43 corresponds to a background region 21 of the vehicle exterior component 20 shown in FIG. 1. The projection 44 corresponds to a pattern region 22 of the vehicle exterior component 20. The pattern region 22 includes a character portion 23 and a ring-shaped portion 24, which extends around the character portion 23.

### Light Shield

As shown in FIGS. 2 and 3, the light shield includes a peripheral light shield 47 and a central light shield 48. The peripheral light shield 47 and the central light shield 48 are formed from, for example, a mixture of PC and carbon black. The peripheral light shield 47 and the central light shield 48 absorbs light to block the transmission of light. The peripheral light shield 47 extends along a peripheral portion 45 of the inner base 42 and thus has the shape of an elliptical ring. The peripheral light shield 47 is arranged in contact with the peripheral portion 45. The central light shield 48 is encompassed by the peripheral light shield 47 and located outward from the general portion 43 of the inner base 42.

### Outer Base 51

The outer base 51 is transmissive to millimeter waves in the same manner as the inner base 42. The outer base 51 is formed from a transparent plastic material, which serves as the transparent material, in the same manner as the inner base 42. The outer base 51 is located outward from the inner base 42 and the light shield (peripheral light shield 47 and central light shield 48). The outer base 51 is formed from a translucent plastic material, which serves as the translucent material.

The inner part of the outer base 51 is shaped in conformance with the outer sides of the inner base 42 and the light shield. The inner part of the outer base 51, at the outer side of the projection 44 of the inner base 42, includes a recess 52, which is recessed toward the outer side. Further, a peripheral portion 53 of the outer base 51 has an inner surface including a ring-shaped recess 54, which is recessed toward the outer side. The ring-shaped recess 54 is arranged in contact with the outer side of the peripheral light shield 47. The inner part of the outer base 51 at the outer side of the central light shield 48 includes a recess 55, which is recessed toward the outer side. The recess 55 is arranged in contact with the outer side of the central light shield 48.

### Decorative Layer 60

Referring to FIG. 3, the decorative layer 60 is for decorating the ornamental body 41. The inner base 42 is formed on one side of the decorative layer 60, and the central light shield 48 and the outer base 51 are formed on the other side of the decorative layer 60. More specifically, the decorative layer 60 is located at the outer side of the projection 44 and formed between the projection 44 and the recess 52. Further, the decorative layer 60 is located at the outer side of the general portion 43 and formed between the central light shield 48 and the general portion 43. In other words, the decorative layer 60 is laminated to the outer side of the inner base 42 and the inner side of the outer base 51.

The decorative layer 60 includes a first colored layer 61, a second colored layer 62, a third colored layer 63, and a fourth colored layer 64, each of which is transmissive to millimeter waves. The first colored layer 61, the second colored layer 62, the third colored layer 63, and the fourth colored layer 64 are laminated in this order from the outer side to the inner side.

The decorative layer 60 is formed so that when the ornamental body 41 is viewed from the outer side, the pattern region 22 (character portion 23 and ring-shaped portion 24) has a specified color.

More specifically, in a dark environment, such as during nighttime, when the light sources 81 are on, the pattern region 22 has the same color as the light emitted from the light sources 81.

The decorative layer 60 differs from Japanese Laid-Open Patent Publication No. 2005-88652 in that fine holes do not extend through the decorative layer 60.

### First Colored Layer 61

The first colored layer 61 is light-transmissive and formed from a pigmented coat. In the present embodiment, the first colored layer 61 is formed from a blue pigmented coat. If the blue color of the first colored layer 61 were to be too dark, the white light emitted from the light sources 81 may become bluish when passing through the first colored layer 61. Thus, the first colored layer 61 is set to be perceived as light blue.

More specifically, the first colored layer 61 is formed by a colored clear coat, which serves as the pigmented coat. The colored clear coat is colored by adding, to a clear coat, at least one of pigment and dye (only pigment, only dye, or both pigment and dye). In this case, the colored clear coat is blue. The clear coat is a typical clear coat of an acrylic plastic, an urethane plastic, a polyester plastic, an epoxy plastic, or the like.

### Second Colored Layer 62

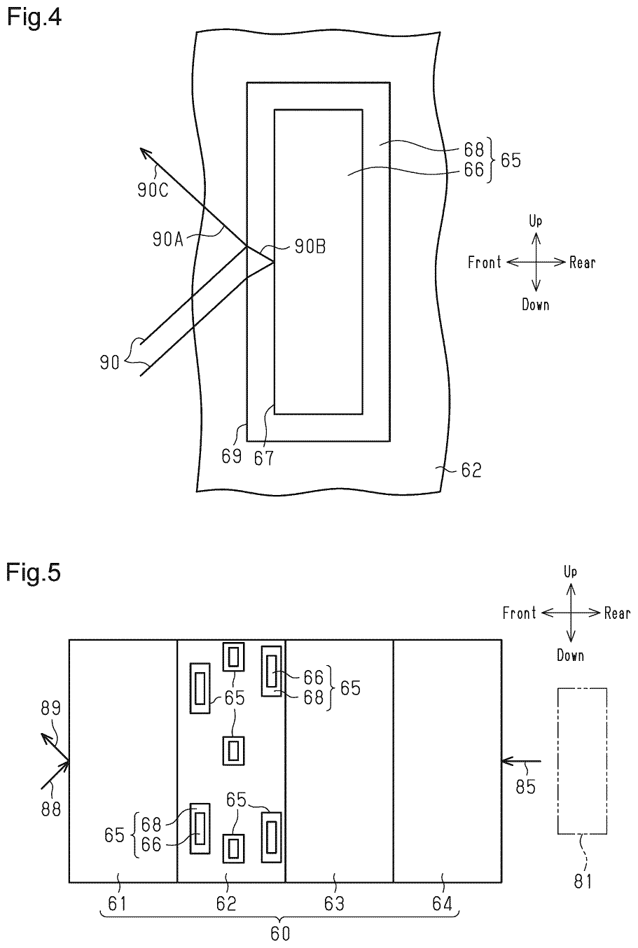

Referring to FIGS. 4 and 5, the second colored layer 62 reduces the effect of the white light emitted from the light sources 81 so that the pattern region 22 has a specified color when viewed from the outer side of the vehicle. The specified color may differ from the color of the first colored layer 61 or be darker than the first colored layer 61. The second colored layer 62 is laminated to the inner side of the first colored layer 61. The second colored layer 62 is formed by dispersing fillers 65, which serve as a brightness enhancer, in a blue coat, which is transmissive to the light emitted from the light sources 81.

The fillers 65 each include a filler body 66, which is formed by mica or the like, and a coating 68, which covers the filler body 66. The filler body 66 may be a metal filler, such as an aluminum filler. The coating 68 is formed by a pigmented coat of which a color difference ΔE from the pigmented coat of the first colored layer 61 is 30 or less. The color difference ΔE between the two pigmented coats is preferably 25 or less, and further preferably 10 or less. In the present embodiment, the coating 68 is formed from a pigmented coat including purple pigment. The measured color difference ΔE was 25 between the purple pigmented coat of the coating 68 and the blue pigmented coat of the first colored layer 61.

### Third Colored Layer 63

The third colored layer 63 shown in FIG. 3 is formed from a smoke clear coat including a transparent plastic and a dark colorant. The third colored layer 63 is laminated to the inner side of the second colored layer 62. Preferably, the transparent plastic material is, but not limited to, a plastic material having superior light resistance such as an acrylic plastic. The colorant is, for example, black pigment.

### Fourth Colored Layer 64

The fourth colored layer 64 shown in FIG. 3 is formed by a pigmented coat that is colored to have a color-complementing relationship with the first colored layer 61. When two colors are mixed in a fixed ratio to produce a specific color (such as white for light), a complementary color is the color opposite the specific color on the color wheel. The first colored layer 61 is blue that has a color-complementing relationship with yellow. In the present embodiment, the fourth colored layer 64 is formed by adding a yellow colorant to a clear coat, resulting in a yellow clear coat.

### Hard Coat Layer 71

The hard coat layer 71 is transparent and transmissive to millimeter waves. The hard coat layer 71 is formed by applying a known hard coat agent to the outer surface of the outer base 51. Examples of a hard coat agent include an inorganic hard coat agent, an organic-inorganic hard coat agent, and an organic hard coat agent of acrylate, oxetane, silicone, or the like. The outer surface of the hard coat layer 71 forms an ornamental surface of the vehicle exterior component 20.

The hard coat layer 71 protects the outer base 51 from scratches. Further, the hard coat layer 71 provides the vehicle exterior component 20 with resistance to deformation and deterioration that would be caused by sunshine, weather, temperature changes, and the like.

### Light Sources 81

As shown in FIG. 2, a peripheral portion 32 of the housing 31 is joined with the peripheral light shield 47, which forms the peripheral portion of the ornamental body 41. The region between the housing 31 and the ornamental body 41 encompassed within the joined portion (peripheral portion 32 and peripheral light shield 47) defines a retaining portion 73. The retaining portion 73 includes a passage region 74 (refer to FIG. 1) at a part located inward from the joined portion to allow for passage of the millimeter waves transmitted from the millimeter wave radar device 12.

The light sources 81 are formed by light-emitting diode (LED) chips. Multiple light sources 81 are used in the present embodiment. Each light source 81 is formed by mounting an LED element 83 on a substrate 82.

The light sources 81 are arranged in the housing 31, that is, in the retaining portion 73, at locations separated from the passage region 74. In the present embodiment, some of the light sources 81 are positioned at distances upward from the passage region 74, while the other light sources 81 are positioned at distances downward from the passage region 74.

The light sources 81 are arranged so that the emitted light is diffusively reflected by the housing 31 and directed toward the inner base 42. The light sources 81 are arranged so that the LED elements 83 are located at the inner side of the substrate 82. Further, the LED element 83 of each light source 81 emits light having a specific color, white in the present embodiment, in the inward direction from the outer side of the housing 31.

The light sources 81 are off when the vehicle 10 is in a bright environment, such as during daytime. The light sources 81 are on when the vehicle 10 is in a dark environment, such as during nighttime. The light sources 81 may be turned on and off automatically or manually. When the light sources 81 are turned on automatically, for example, a sensor detects the brightness of the environment that the vehicle 10 is in, and a controller controls and turns on or off the light sources 81 in accordance with the detection result of the sensor.

The vehicle exterior component 20 is attached to the front grille 11 is a state held upright in the window 13 of the front grille 11. The structure for attaching the vehicle exterior component 20 to the front grille 11 is not particularly limited. The vehicle exterior component 20 may be attached to the front grille 11 by clips, screws, hooks, and/or the like. The vehicle exterior component 20 may be attached to a vehicle body (not shown) instead of the front grille 11.

The operation of the present embodiment will now be described.

### Recognition of Objects by Millimeter Wave Radar Device 12

When the millimeter wave radar device 12 shown in FIG. 2 transmits millimeter waves in the outward direction, the millimeter waves sequentially pass through the housing 31 and the ornamental body 41 in the passage region 74.

The LED element 83 of each light source 81 is positioned in the retaining portion 73 separated upward or downward from the passage region 74. Thus, the millimeter waves transmitted from the millimeter wave radar device 12 pass through the part of the retaining portion 73 where the light sources 81 are not located. The light sources 81 do not interfere with the millimeter waves transmitted from the millimeter wave radar device 12.

The millimeter waves transmitted through the ornamental body 41 are reflected when striking an object outside the vehicle 10, such as another vehicle (front vehicle) or a pedestrian, and then are passed sequentially through the ornamental body 41 and the housing 31. The millimeter waves are received by the millimeter wave radar device 12.

The millimeter wave radar device 12 recognizes the object from the transmitted and received millimeter waves and calculates the distance, the relative velocity, and the like between the vehicle 10 and the object.

### Light Sources 81 Off

As shown in FIGS. 1 and 2, when the vehicle 10 is in a bright environment, such as during daytime, and the light sources 81 are off, some of the light entering the ornamental body 41 sequentially passes through the hard coat layer 71 and the outer base 51.

Some of the light passing through the outer base 51 is absorbed by the peripheral light shield 47 and the central light shield 48. The peripheral light shield 47 and the central light shield 48 are visible from the outer side of the vehicle 10 through the hard coat layer 71 and the outer base 51. The peripheral light shield 47 and the central light shield 48 are perceived as being blackish. Members at the inner side of the peripheral light shield 47 and the central light shield 48 are not visible or subtly visible.

With reference to FIG. 5, light that passes through the outer base 51 and then strikes the first colored layer 61 is referred to as light 88. Light that is reflected by the outer surface of the first colored layer 61 is referred to as light 89. Light 89 sequentially passes through the outer base 51 and the hard coat layer 71 and then exits the outer surface of the hard coat layer 71.

Some of the light from the outer side entering the ornamental body 41 and sequentially passing through the hard coat layer 71 and the outer base 51 then passes through the first colored layer 61 and strikes the fillers 65 in the second colored layer 62. Such light is referred to as light 90 and distinguished from other light.

As shown in FIG. 4, some of the light 90 striking each filler 65 is reflected as a first light component 90A by a surface 69 of the coating 68. Further, some of the light 90 striking the filler 65 passes through the coating 68, without being reflected by the surface 69 of the coating 68, and is reflected as a second light component 90B by a surface 67 of the filler body 66. The first light component 90A is superimposed with the second light component 90B thereby intensifying the combined light. Intensified light 90C exits the outer side of the first colored layer 61. Light 90C combines with light 89, which is reflected by the outer surface of the first colored layer 61, and produces navy-colored light. The navy-colored light sequentially passes through the outer base 51 and the hard coat layer 71 and then exits the outer surface of the hard coat layer 71. Thus, when the vehicle exterior component 20 is viewed from the outer side, the pattern region 22 (character portion 23 and ring-shaped portion 24) of the decorative layer 60 is navy-colored. This effect is obtained when the color difference ΔE is 30 or less between the coatings 68 of the filler bodies 66 and the pigmented coat of the first colored layer 61.

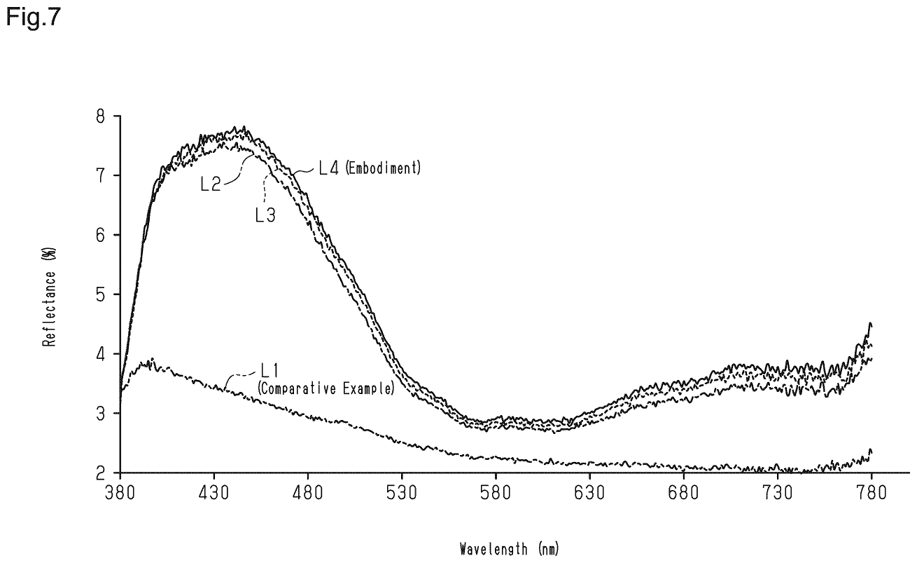

FIG. 7 shows the reflectance of the decorative layer 60 illuminated with light from the outer side, measured for different wavelengths. In FIG. 7, characteristic line L1, which is the double-dashed line, shows the measurement of a comparative example in which the decorative layer 60 includes only the first colored layer 61. Characteristic line L2, which is the single-dashed line, shows the measurement when the decorative layer 60 is formed by the first colored layer 61 and the second colored layer 62. Characteristic line L3, which is the broken line, shows the measurement when the decorative layer 60 is formed by the first colored layer 61, the second colored layer 62, and the third colored layer 63. Characteristic line L4, which is the broken line, shows the measurement of the decorative layer 60 in the present embodiment formed by the first colored layer 61, the second colored layer 62, the third colored layer 63, and the fourth colored layer 64.

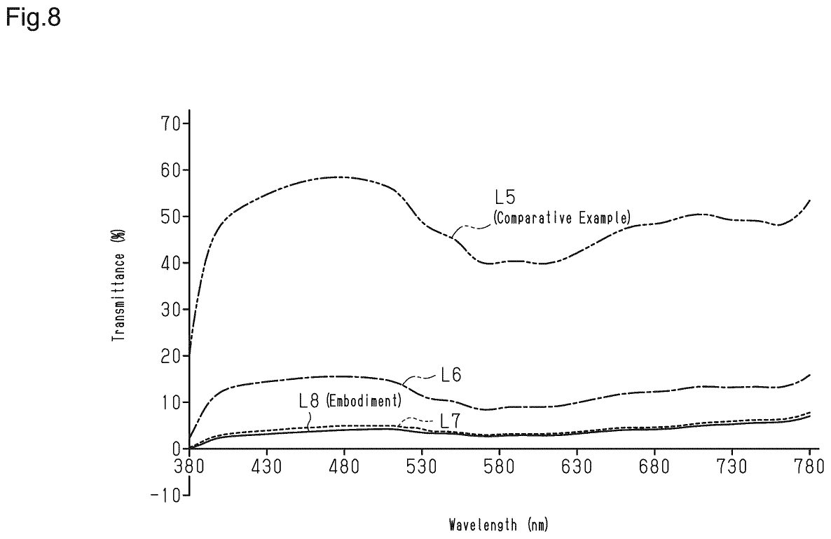

FIG. 8 shows the transmittance of the decorative layer 60 illuminated with light from the outer side, measured for different wavelengths. In FIG. 8, characteristic line L5, which is the double-dashed line, shows the measurement of the comparative example. Characteristic line L6, which is the single-dashed line, shows the measurement when the decorative layer 60 is formed by the first colored layer 61 and the second colored layer 62. Characteristic line L7, which is the broken line, shows the measurement when the decorative layer 60 is formed by the first colored layer 61, the second colored layer 62, and the third colored layer 63. Characteristic line L8, which is the solid line, shows the measurement of the present embodiment.

In the measurements of FIGS. 7 and 8, the first colored layer 61, the third colored layer 63, and the fourth colored layer 64 each have a thickness of 8 μm, and the second colored layer 62 has a thickness of 7 μm.

The light in the wavelength band of 460 to 480 nm is perceived as blue. In this wavelength band, as shown by characteristic line L1 of the comparative example, the decorative layer 60 that includes only the first colored layer 61 has a reflectance of approximately 3% and is relatively low. Further, as shown by characteristic lines L2 to L4, when the decorative layer 60 includes at least one of the colored layers 62 to 64 in addition to the first colored layer 61, the reflectance is 5% to 8% and relatively high.

In the above wavelength band, as shown by characteristic line L5 of the comparative example, when the decorative layer 60 includes only the first colored layer 61, the transmittance is 40% to 60% and relatively high. Further, as shown by characteristic lines L6 to L8, when the decorative layer 60 includes at least one of the colored layers 62 to 64 in addition to the first colored layer 61, the transmittance is 5% to 15% and relatively low.

As described above, FIGS. 7 and 8 show that in the wavelength band in which light is perceived as blue, the amount of the light 89 reflected by the first colored layer 61 is small, and the amount of light transmitted through the first colored layer 61 is large. However, a large amount of the light transmitted through the first colored layer 61 is reflected by the second colored layer 62, and a small amount of the light is transmitted through the second colored layer 62.

Further, as shown in FIGS. 4 and 5, with regard to the second colored layer 62, the first light component 90A is superimposed with the second light component 90B thereby intensifying the combined light. The intensified light 90C is combined with the light 89 reflected by the outer surface of the first colored layer 61. As a result, the pattern region 22 of the decorative layer 60 is perceived to be navy-colored, which is the color of the combined light.

If the decorative layer 60 were to be formed by only the first colored layer 61 and the second colored layer 62, when the light sources 81 are off, components and parts that are arranged at the inner side of the ornamental body 41 may be visible through the ornamental body 41.

In this respect, in the present embodiment, the third colored layer 63, which is located at the inner side of the second colored layer 62 and formed from a smoke clear coat, reduces the transmitted light. This can be understood from characteristic line L7 and characteristic line L8 in FIG. 8. Compared with when the decorative layer 60 is formed by the first colored layer 61 and the second colored layer 62 (characteristic line L6), the transmittance is smaller when the third colored layer 63 is further added (characteristic lines L7 and L8).

The third colored layer 63 lowers the L value, which represents lightness in the Lab color space, and further darkens the navy-colored light. Thus, components and parts located inward from the ornamental body 41 will be less visible through the ornamental body 41 from the outer side.

As shown in FIG. 3, in the pattern region 22, the decorative layer 60 is formed between the recess 52 and the projection 44. Thus, the decorative layer 60 appears to be three-dimensional and bulged frontward.

### Light Sources 81 On

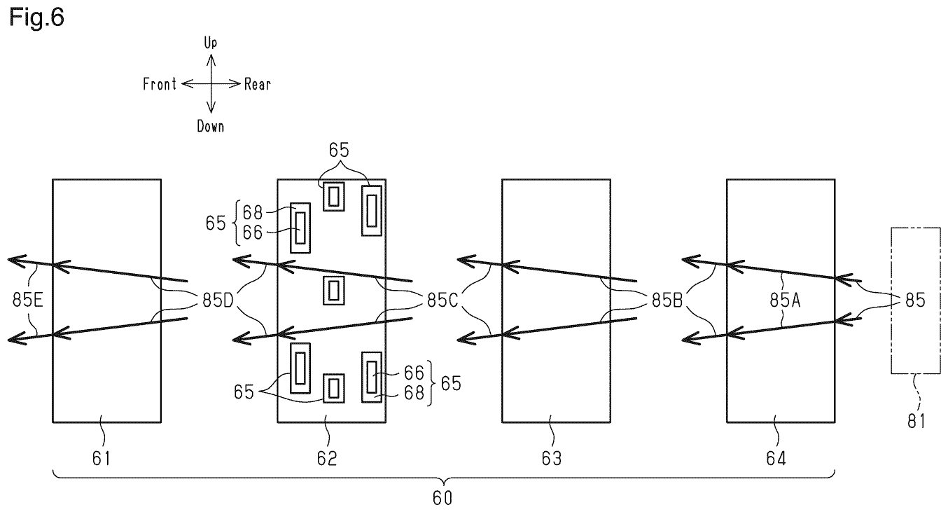

As shown in FIG. 2, when the vehicle 10 is in a dark environment, such as during nighttime, and the light sources 81 are on, the LED element 83 of each light source 81 emits light toward the housing 31, which diffusively reflects the light. The diffusively reflected light illuminates the inner surface of the ornamental body 41. The light passes through the inner base 42 and then enters the decorative layer 60. With reference to FIGS. 5 and 6, light that strikes the decorative layer 60 from the inner side is referred to as light 85. The light 85 sequentially passes through the fourth colored layer 64, the third colored layer 63, the second colored layer 62, and the first colored layer 61 of the decorative layer 60. The light 85 changes color as it passes through the decorative layer 60.

FIG. 6 shows the colored layers 64 to 61 in a state separated from one another to illustrate how the light 85 changes color. The light 85 passing through each of the colored layers 64 to 61 is distinguished by the alphabetical character added to the reference number of light 85.

White light 85 enters the fourth colored layer 64. Light 85A becomes yellow as it passes through the fourth colored layer 64, which is also yellow. More specifically, in the white light 85, light in the same wavelength band as the color of the fourth colored layer 64 smoothly passes through the fourth colored layer 64. The fourth colored layer 64 hinders the passage of light in a wavelength band differing from that of the color (yellow) of the fourth colored layer 64.

Thus, the fourth colored layer 64 emits yellow light 85B that enters the third colored layer 63. When the light 85B passes through the third colored layer 63, the light 85B subtly changes in color.

The third colored layer 63 emits yellow light 85C that enters the second colored layer 62. The light that enters the third colored layer 63 and the light that exits the third colored layer 63 have substantially the same color, which is yellow. In the second colored layer 62, the yellow light 85C passes through the gaps between the fillers 65 in the second colored layer 62. When passing through the second colored layer 62, the light 85C subtly changes in color.

The second colored layer 62 emits yellow light 85D that enters the first colored layer 61. The light that enters the second colored layer 62 and the light that exits the second colored layer 62 have substantially the same color, which is yellow.

The first colored layer 61 is formed by a colored clear coat and is bluish and transparent. The first colored layer 61 has a light blue color. Thus, the light 85D will not become bluish when passing through the first colored layer 61.

As described above, the yellow fourth colored layer 64 has a color-complementing relationship with the blue first colored layer 61. In other words, the color of the first colored layer 61 has a color-complementing relationship with the color of the fourth colored layer 64. Thus, the yellow light 85D changes to white light when passing through the first colored layer 61. The first colored layer 61 emits white light 85E, which is similar to the light emitted from the light sources 81.

The white light 85E passes through the outer base 51 and the hard coat layer 71, which are shown in FIG. 3, and is then emitted from the outer surface of the hard coat layer 71. Thus, the light 85E emitted from the hard coat layer 71 is perceived as being white. The pattern region 22 (character portion 23 and ring-shaped portion 24) is perceived as being white.

The advantages of the present embodiment will now be described.

(1) As shown in FIGS. 4 and 5, in the present embodiment, the decorative layer 60 includes the first colored layer 61 and the second colored layer 62, which is laminated to the inner side of the first colored layer 61. The first colored layer 61 is formed from a pigmented coat that is transmissive to light. The second colored layer 62 is formed from a coat that is transmissive to light and includes the dispersed fillers 65. The fillers 65 each include the filler body 66 and the coating 68 covering the filler body 66. The coating 68 is formed by a pigmented coat of which the color difference ΔE from the pigmented coat of the first colored layer 61 is 30 or less.

When the light sources 81 are off, such as during daytime, the pattern region 22 is perceived as being navy-colored. When the light sources 81 are on, such as during nighttime, light passes through the ornamental body 41 and illuminates the pattern region 22.

In this manner, the pattern region 22 is perceived as having different colors depending on whether the light sources 81 are off and on. This improves the aesthetic appeal when the light sources 81 are off and when they are on.

(2) The decorative layer 1 differs from Japanese Laid-Open Patent Publication No. 2005-88652 in that the decorative layer 60 does not include fine holes that may be visible from the outer side. That is, there are no holes that the light emitted from the light sources 81 would pass through. Thus, there are no holes that would reduce the light passing through the ornamental body 41. Further, the character portion 23 and the ring-shaped portion 24 in the pattern region 22 will not be dark when illuminated.

This improves the aesthetic appeal when the light sources 81 are off and when they are on and results in the same advantage as advantage (1).

(3) The hue (color tone) of the pattern region 22 of the decorative layer 60 perceived when viewing the vehicle exterior component 20 from the outer side may be adjusted in accordance with the color difference ΔE. For example, the color of the pigmented coat for the first colored layer 61 and the color of the pigmented coat for the coatings 68 are selected so that the color difference ΔE has a relatively large value that is 30 or less. This allows the pattern region 22 to be perceived as having a color that differs from that of the first colored layer 61. Further, the colors of the two pigmented coats may be selected so that the color difference ΔE has a relatively small value. This allows the pattern region 22 to be perceived as being darker than the first colored layer 61.

(4) In the present embodiment, the first colored layer 61 is formed by a clear coat colored by adding at least one of pigment and dye. When the white light emitted from the light sources 81 passes through the first colored layer 61, the light will not be affected by pigment and dye. That is, in the present embodiment, the white light will not become bluish.

(5) In the present embodiment, the decorative layer 60 includes the third colored layer 63, which is formed by a smoke clear coat. Thus, when the light sources 81 are off, the third colored layer 63 will hide the components and parts located inward from the ornamental body 41 so that they will not be visible through the ornamental body 41 from the outer side. This also improves the aesthetic appeal.

(6) In the present embodiment, the light sources 81 emit white light. The decorative layer 60 includes the fourth colored layer 64 that is located inward from the second colored layer 62 and has a color having a color-complementing relationship with the first colored layer 61. Thus, when the light sources 81 are on, the pattern region 22 is illuminated with light having a white color that is similar to the color of the light emitted from the light sources 81.

(7) As shown in FIG. 2, in the present embodiment, the housing 31 and the ornamental body 41 of the vehicle exterior component 20, which is located outward from the millimeter wave radar device 12, are transmissive to millimeter waves. Thus, the housing 31 and the ornamental body 41 do not interfere with the millimeter waves transmitted from and received by the millimeter wave radar device 12.

Further, in the present embodiment, the light sources 81 in the housing 31 are arranged in a region between the housing 31 and the ornamental body 41 outside the passage region 74 of millimeter waves. Thus, the light sources 81 do not interfere with the millimeter waves transmitted from the millimeter wave radar device 12.

The above embodiments may be modified as described below. The above embodiment and the modified examples described below may be combined as long as there is no technical contradiction.

### Light Sources 81

The light emitted from the light sources 81 may be oriented directly toward the inner base 42 instead of being reflected by the housing 31. In other words, the light sources 81 may be arranged to emit light toward the inner base 42.

The number of the light sources 81 may differ from that of the above embodiment. The minimum number of the light sources 81 is one.

The light sources 81 may be positioned in the retaining portion 73 separated leftward and rightward from the passage region 74 instead of or in addition to being positioned upward and downward from the passage region 74.

The light sources 81 do not have to be LEDs and may be light sources that do not use the electroluminescent principle to emit light. For example, the light sources 81 may emit light through incandescence, fluorescence, discharge, chemiluminescence, laser, or the like.

The light sources 81 may emit light of a color other than white.

### Position of Decorative Layer 60

The inner base 42 may be omitted so that the base includes only the outer base 51. In this case, the decorative layer 60 is laminated to the inner side of the base.

The outer base 51 may be omitted so that the base includes only the inner base 42. In this case, the decorative layer 60 is laminated to the outer side of the base.

### Structure of Decorative Layer 60

The first colored layer 61 may be formed by a pigmented coat (pigmented clear coat) having a color other than blue.

The first colored layer 61 may be formed by a pigmented coat instead of a clear coat. The same applies to the fourth colored layer 64.

As long as the color difference ΔE is 30 or less, the combination of the pigmented coat color of the first colored layer 61 and the pigmented coat color of the coating 68 may differ from that of the above embodiment, in which a blue pigmented coat is used for the first colored layer and a purple pigmented coat is used for the coating.

The third colored layer 63 may be omitted, and the decorative layer 60 may be formed by the first colored layer 61, the second colored layer 62, and the fourth colored layer 64.

The fourth colored layer 64 may be omitted, and the decorative layer 60 may be formed by the first colored layer 61, the second colored layer 62, and the third colored layer 63.

The third colored layer 63 and the fourth colored layer 64 may be omitted, and the decorative layer 60 may be formed by the first colored layer 61 and the second colored layer 62.

### Sensor

The sensor may detect an object outside the vehicle using electromagnetic waves that are not millimeter waves, for example, by transmitting and receiving infrared waves.

The sensor may be installed at a location that differs from the front part of the vehicle 10, for example, the rear part of the vehicle 10. In this case, the sensor transmits electromagnetic waves rearward from the vehicle 10.

Further, the sensor may be installed in a front corner or rear corner of the vehicle 10. In this case, the sensor transmits electromagnetic waves from the vehicle 10 in a diagonally frontward direction or a diagonally rearward direction.

In such a case, the vehicle exterior component 20 is arranged in front of the sensor with respect to the transmission direction of the electromagnetic waves, that is, at the outer side of the sensor.

### Others

The vehicle exterior component 20 may be incorporated in a vehicle that does not include a sensor for detecting an object outside the vehicle by transmitting and receiving electromagnetic waves.

The vehicle exterior component 20 of the present disclosure may be applied to any component that emits light and is attached to the exterior of the vehicle 10 to decorate the vehicle 10. Examples of the vehicle exterior component 20 include an emblem, an ornament, a mark, a front grille, a rear grille, and a side bezel.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A vehicle exterior component, comprising:
a housing arranged in a vehicle;
an ornamental body located outward from the housing with respect to the vehicle; and
a light source arranged in the housing to emit light that strikes an inner surface of the ornamental body, the inner surface of the ornamental body facing inward with respect to the vehicle, wherein
the ornamental body includes a base formed from a transparent or translucent material, and a decorative layer laminated to an outer surface or an inner surface of the base, the outer surface of the base being located outward from the inner surface of the base with respect to the vehicle,
the decorative layer includes
a first colored layer that is light-transmissive and formed from a pigmented coat, and
a second colored layer that is light-transmissive, laminated to an inner side of the first colored layer, and includes fillers dispersed in a coat, the inner side of the first colored layer facing inward with respect to the vehicle,
the fillers each include a filler body and a coating that coats the filler body, and
the coating is formed by a pigmented coat of which a color difference ΔE from the pigmented coat of the first colored layer is 30 or less.

2. The vehicle exterior component according to claim 1, wherein the first colored layer is formed by a colored clear coat that is colored by adding at least one of pigment and dye to a clear coat.

3. The vehicle exterior component according to claim 1, wherein the decorative layer further includes a third colored layer formed by a smoke clear coat, and the third colored layer is located inward from the second colored layer with respect to the vehicle.

4. The vehicle exterior component according to claim 1, wherein
the light source emits white light,
the decorative layer further includes a fourth colored layer that is colored to have a color-complementing relationship with the first colored layer, and
the fourth colored layer is located inward from the second colored layer with respect to the vehicle.

5. The vehicle exterior component according to claim 1, wherein
the vehicle includes a sensor that detects an object outside the vehicle by transmitting and receiving electromagnetic waves,
the housing is located outward from the sensor with respect to the vehicle,
the housing and the ornamental body are transmissive to the electromagnetic waves, and
the light source is arranged in a region between the housing and the ornamental body outside a passage region of the electromagnetic waves transmitted from the sensor.
